(19) United States
(12) Patent Application Publication
(10) Pub. No.: US 2010/0317859 A1
(43) Pub. Date: Dec. 16, 2010

(54) Process for the Preparation of Risedronate Sodium

(75) Inventors: Neela Praveen Kumar, Andhra Pradesh (IN); Dnyaneshwar Singare, Maharashtra (IN); Nitin Sharadchandra Pradhan, Maharashtra (IN); Jon Valgeirsson, Hafnarfjordur (IS)

Correspondence Address: CANTOR COLBURN LLP, 20 Church Street, 22nd Floor, Hartford, CT, 06103, US

(73) Assignee: ACTAVIS GROUP PTC EHF, Hafnarfjordur (IS)

(21) Appl. No.: 12/599,980

(22) PCT Filed: May 16, 2008
(86) PCT No.: PCT/IB08/02391

§ 371 Date: Sep. 1, 2010

(30) Foreign Application Priority Data
May 16, 2007 (IN) 1038/CHE/2007

(51) Int. Cl. C07F 9/28

(52) U.S. Cl. 546/22

(57) ABSTRACT

Disclosed herein is an improved, commercially viable and industrially advantageous process for the preparation of risedronic acid or a pharmaceutically acceptable salt thereof, in high yield and purity.

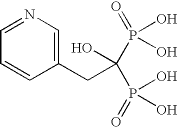

### CROSS REFERENCE TO RELATED APPLICATION

This application claims priority from Indian Provisional Application No. 1038/CHE/2007 filed on May 16, 2007, which is hereby incorporated by reference in its entirety.

### FIELD OF THE DISCLOSURE

Disclosed herein is an improved, commercially viable and industrially advantageous process for the preparation of risedronic acid or a pharmaceutically acceptable salt thereof, in high yield and purity.

### BACKGROUND OF THE INVENTION

Risedronic acid, also known as [1-hydroxy-2-(3-pyridinyl)ethylidene] bisphosphonic acid, is represented by the following structural formula:

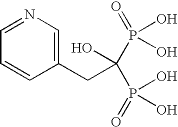

Bisphosphonic acids, such as risedronic acid, and pharmaceutically acceptable salts thereof, are useful for the treatment of diseases of bone and calcium metabolism. Such diseases include osteoporosis, hyperparathyroidism, hypercalcemia of malignancy, ostolytic bone metastases, myosistis ossifcans progressiva, calcinoisis universalis, arthritis, neuritis, bursitis, tendonitis and other inflammatory conditions.

Risedronic acid and related compounds were initially disclosed in European Patent No. EP 186405, describing the bisphosphonate compounds and pharmaceutical compositions comprising said compounds. Risedronic acid is usually administered orally in the form of a suitable salt, e.g., in the form of sodium salt. This drug was approved under the trademark ACTONEL®, by the U.S. Food and Drug Administration and it is available in the form of its monosodium salt. ACTONEL (Risedronate sodium) is a pyridinyl bisphosphonate that inhibits osteoclast-mediated bone resorption and modulates bone metabolism. Each ACTONEL tablet for oral administration contains the equivalent of 5, 30, 35, or 75 mg of anhydrous risedronate sodium in the form of the hemi-pentahydrate with small amounts of monohydrate.

Various processes for the preparation of Risedronic acid and related compounds are disclosed in European Patent Nos. EP 186405, EP 715631 and EP 1243592; U.S. Pat. Nos. 6,410,520, 6,562,974 and 7,038,083; U.S. Patent Application Nos. 2005/288509, 2005/063779, 2006/0258625, 2006/0122395 and 2006/0293524; and PCT Publication Nos. WO 93/24498, WO 2005/063779, WO 2006/071128 and WO 2006/129056.

European Patent No. 186405 (hereinafter referred to as the '405 patent) describes a process for the preparation of risedronic acid analogue, 2-(2-pyridyl)-1-hydroxyethane-1,1-diphosphonic acid by reacting 2-pyridylacetic acid with phosphorous acid and phosphorous trichloride in chlorobenzene on a boiling water bath, with the yield of 52%. However, technical data is not provided concerning the manufacture of risedronic acid. Disclosed process for the preparation of 1-hydroxy-2-(2-pyridyl)ethane-1,1-diphosphonic acid separation comprises cooling the final reaction mixture on an ice bath, decanting the chlorobenzene solution from solidified product, followed by warming the solidified product for several hours in a boiling water bath, filtering through celite and precipitating with methanol. After cooling, the precipitated solid was filtered and washed several times with various solvents and dried. Above operations are too complicated to be carried out in a large scale, require multiple temperature changes of the reaction mixture, and do not provide the final product of the suitable purity.

PCT Publication No. WO 93/24498 (hereinafter referred to as the '498 application) describes a process for the preparation of risedronic acid comprising adding 3-pyridylacetic acid hydrochloride, phosphorous acid and chlorobenzene to a flask, placing the flask in a boiling water bath, adding drop wise phosphorous trichloride. The mixture is stirred for 3 hours at 100° C. and a yellow, gummy oil forms during the course of this reaction. After cooling the reaction mixture and removal of the excess chlorobenzene, the oil is hydrolyzed by using 1N HCl, cooled, and the first crop of crystals is filtered and washed with ethanol. The filtrate is evaporated to oil, and a small amount of water is added to dissolve the oil. Ethanol is added to induce crystallization. The second crop of crystals is filtered and washed with ethanol and combined with the first crop. The combined crops were recrystallized from hot water.

A known process for the preparation of risedronic acid described in Journal of Organic Chemistry, Vol. 60, No 25, pp. 8310-8312 (1995) comprises a reaction of 3-pyridylacetic acid with phosphorous acid and phosphorous trichloride. According to the teaching of the above-cited paper, the major technical problem is the solidification of a reaction mixture into the vitreous solid which makes any agitation virtually impossible, and renders work-up and separation of risedronic acid very difficult. The article also mentions general efforts, not described in detail, to conduct the reaction in other more acceptable solvents, such as ethers and inert solvents, such as hexane and chlorobenzene, to provide reaction mixture in a form of a homogeneous solution or dispersion. In order to avoid this problem methanesulfonic acid was used as solvent. In this case yield is about 39%. Although the problem of the solidification of the reaction mixture was resolved, the major problem of above process is rather low yield, as well as a toxicity and aggressiveness of methanesulfonic acid and risks to the environment. The use of methanesulfonic acid as a solvent is not advisable for scale up operations.

U.S. Pat. No. 6,410,520 describes selective crystallization method of risedronate sodium as a hemi-pentahydrate or monohydrate by controlling the nucleation temperature and rate of crystallization. The ratio of hemi-pentahydrate to monohydrate crystal forms in the product can be effectively controlled by varying the water to risedronate sodium ratio and isopropanol to water ratio as well as the temperature. The patent describes a process which selectively produces hemi-pentahydrate and monohydrate forms of risedronate sodium comprising providing an aqueous solution of 3-pyridyl-1-hydroxyethylidene-1,1-bisphosphonic acid sodium; heating the aqueous solution to a temperature from about 45° C. to about 75° C.; adding a solvent to the aqueous solution; and optionally cooling the aqueous solution.

U.S. Pat. No. 6,562,974 (hereinafter referred to as the '974 patent) describes a process for the preparation of risedronic acid by reacting 3-pyridylacetic acid with phosphorous acid and phosphorous trichloride in the presence of a base such as pyridine. As per the process exemplified in the '974 patent, risedronic acid is prepared by melting a mixture of phosphorous acid, pyridine hydrochloride and 3-pyridylacetic acid at 80-90° C. to form a uniform melt followed by the addition of pyridine and then cooled the mixture to about 70° C. Phosphorous trichloride is slowly added to the reaction mixture and then heated at about 70° C. Water and HCl are added to the resulting mass followed by hydrolysis to yield risedronate after crystallization from aqueous acid/IPA.

European Patent No. 1243592 (hereinafter referred to as the '592 patent) describes a process for the preparation of risedronic acid by reacting 3-pyridylacetic acid or its hydrochloride salt with phosphorous acid and phosphorous trichloride in a solvent, characterized in that it comprises reacting 3-pyridylacetic acid with phosphorous acid and phosphorous trichloride in chlorobenzene at the temperature in the range of 85-100° C. or in fluorobenzene at the reflux temperature of the reaction mixture, removing the solvent, and isolating pure risedronic acid, wherein said pure risedronic acid is isolated by treating raw risedronic acid, preferably without separating it from the reaction mixture, with alkali metal or ammonium hydroxide, bicarbonate or carbonate, and then treating the resulting alkali metal or ammonium risedronic acid salt with a strong mineral acid like HCl.

PCT Publication No. WO 2005/063779 describes a process for the preparation of risedronic acid by reacting 3-pyridylacetic acid hydrochloride with a mixture of phosphorous acid and phosphorous oxychloride, in the absence of solvents and with a 3-pyridylacetic acid:phosphorous oxychloride:phosphorous acid molar ratio of 1:2-4:8-12.

U.S. Pat. No. 7,038,083 (hereinafter referred to as the '083 patent) describes a process for the preparation of risedronic acid monohydrate comprising the steps of a) combining 3-pyridylacetic acid or its hydrochloride salt, phosphorous acid, and a halophosphorous compound selected from PCl₃, PCl₅, POCl₃, PBr₃, POBr₃, and PBr₅ at a temperature of about 80° C. to about 100° C. in the presence of a diluent that is an aromatic hydrocarbon or a silicone fluid to form a reaction mixture, with the proviso that, when the diluent is an aromatic hydrocarbon, a polyalkylene glycol is not present as a codiluent in the reaction mixture; b) combining the reaction mixture with water, whereby an aqueous and a non-aqueous phase are formed; c) separating the aqueous phase; d) combining the aqueous phase with ethanol whereby a suspension comprising risedronic acid is formed; and e) isolating risedronic acid monohydrate from the suspension.

According to U.S. Patent Application No. 2005/0288509 (hereinafter referred to as the '509 application) risedronic acid is prepared by the reaction of 3-pyridylacetic acid with phosphorous acid and phosphorous trichloride, characterized in that the reaction is conducted in ionic liquids as the reaction solvents, at a temperature of between 15° C. and 120° C.

PCT Publication No. WO 2006/051553 teaches a process for preparing crystalline forms (Form A & Form B) of risedronate sodium by employing a solvent system comprising different compositions of organic solvent in water at room temperature, characterized in that the organic solvent is selected from the group comprising ketones, nitriles, esters, amides, alcohols and ethers. The publication further describes a process for preparing risedronic acid by reacting 3-pyridyl acetic acid with phosphorous acid and phosphorous trichloride in chlorobenzene and adding water to the reaction mixture without decanting or separating chlorobenzene. The reaction mixture is further heated and methanol is added into it to get solid risedronic acid.

U.S. Patent Application No. 2006/122395 describes a process for preparing risedronic acid monohydrate which comprises reacting 3-pyridylacetic acid with phosphorous acid and phosphorous pentoxide in the presence of methanesulfonic acid characterized in that wherein the mole ratio of methanesulfonic acid:phosphorous acid:phosphorous pentoxide in the phosphonylating reagent is between 1-5:1:0.25-1.

PCT Publication No. WO 2006/071128 describes a process for preparing risedronic acid and hemi-pentahydrate monosodium salt thereof by employing phosphorous trichloride as solvent and reagent in the bisphosphorylation reaction characterized in that wherein the molar ratio of 3-pyridinyl acetic acid hydrochloride, phosphorous trichloride and water is 1:6:7.4 (moles).

U.S. Patent Application No. 2006/0258625 describes a process for preparing risedronic acid by employing diphenyl ether as a solvent in the bisphosphorylation reaction.

PCT Publication No. WO 2006/129056 describes a process for the preparation of risedronic acid, which comprises reacting pyridylacetic acid, optionally in the form of a hydrohalide salt, with phosphorous acid, in the presence of phosphorous trihalide, to yield risedronic acid and recovering the thus formed risedronic acid, characterized in that the reaction of said pyridylacetic acid with phosphorous acid is carried out in the absence of an organic solvent.

U.S. Patent Application No. 2006/0293524 describes a process for preparing risedronic acid by employing sulfolane as a solvent in the bisphosphorylation reaction.

Risedronic acid or a pharmaceutically acceptable salt thereof obtained by the processes described in the prior art does not have satisfactory purity. Unacceptable amounts of impurities are generally formed during the bisphosphorylation reaction, thus resulting in a poor product yield. Moreover, the processes suffers from disadvantages such as the use of additional and hazardous reagents like pyridine, diluent like aromatic hydrocarbon or a silicone fluid, hazardous and/or additional amounts of solvents like chlorobenzene, fluorobenzene, methanesulfonic acid, phosphorous oxychloride, ionic liquids, phosphorous pentoxide, phosphorous trichloride, diphenyl ether and sulfolane. Thus, the prior art processes are not advisable for scale up operations.

Based on the aforementioned drawbacks, the prior art processes may be unsuitable for preparation of risedronic acid or a pharmaceutically acceptable salt thereof in commercial scale operations.

A need remains for an improved and commercially viable process of preparing a substantially pure risedronic acid or a pharmaceutically acceptable salt thereof to resolve the problems associated with the processes described in the prior art, and that will be suitable for large-scale preparation. Desirable process properties include less hazardous and environmentally friendly reagents, reduced cost, and greater simplicity, increased purity and increased yield of the product.

### SUMMARY OF THE INVENTION

The present inventors have surprisingly found that risedronic acid can be prepared in high purity and with high yield by using a suitable aliphatic or alicyclic hydrocarbon solvent in the reaction between 3-pyridylacetic acid or an acid addition salt thereof with phosphorous acid in the presence of a suitable activating agent characterized in that the solvent is selected from the group comprising n-heptane, n-octane, cyclohexane, and mixtures thereof.

In one aspect, provided herein is an efficient, convenient, commercially viable and environment friendly process for the preparation of risedronic acid or a pharmaceutically acceptable salt thereof in a 70-75% overall yield. Advantageously, the solvent used for present invention is easy to handle at commercial scale and are also less expensive and non-hazardous than in many prior art processes.

In another aspect, the present invention provides substantially pure risedronic acid or a pharmaceutically acceptable salt thereof having relatively low content of one or more organic volatile impurities.

### DETAILED DESCRIPTION OF THE INVENTION

According to one aspect of the present invention, there is provided an improved process for the preparation of [1-hydroxy-2-(3-pyridinyl)ethylidene]bisphosphonic acid (risedronic acid) or a pharmaceutically acceptable salt thereof, comprising the steps of:
a) forming a reaction mixture (for example by stirring together) of 3-pyridylacetic acid or an acid addition salt thereof with phosphorous acid in a suitable C₆ to C₈ aliphatic or alicyclic hydrocarbon solvent, (for example n-heptane, n-octane, cyclohexane, or mixtures thereof);
b) reacting the reaction mixture obtained in step-(a) with a suitable activating agent;
c) admixing the reaction mass obtained in step-(b) with water;
d) optionally, filtering the reaction mass obtained in step-(c) to remove any extraneous matter; and
e) isolating substantially pure risedronic acid and optionally converting the risedronic acid obtained into its pharmaceutically acceptable salts thereof.

As an acid addition salt used in step-(a), the salt derived from a therapeutically acceptable acid such as hydrochloric acid, hydrobromic acid, acetic acid, succinic acid, maleic acid, fumaric acid, citric acid, glutaric acid, citraconic acid, glutaconic acid, and tartaric acid can be used. Most preferable acid addition salt is hydrochloride.

Most suitable solvent used in step-(a) is n-octane.

The stirring in step-(a) is carried out at a temperature of 25° C. to the reflux temperature of the solvent used for at least 15 minutes, specifically at a temperature of about 40° C. to the reflux temperature of the solvent used from about 20 minutes to about 4 hours, and most specifically at a temperature of about 50° C. to about 100° C. from about 30 minutes to about 3 hours.

As used herein, “reflux temperature” means the temperature at which the solvent or solvent system refluxes or boils at atmospheric pressure.

In an embodiment, the phosphorous acid in the molar ratio of about 3.0 to 5.0 moles, specifically about 3.5 to 4.0 moles, per 1 mole of 3-pyridylacetic acid or an acid addition salt thereof is used in order to ensure a proper course of the reaction.

After completion of the reaction in step-(a), the reaction mixture may optionally be cooled at a temperature of below 70° C., and preferably at about 40° C. to about 65° C.

Exemplary activating agents used in step-(b) include, but are not limited to, oxalyl chloride, phosphorous oxychloride, phosphorous trichloride, phosphorous pentachloride, phosphorous tribromide and the like, and combinations comprising one or more of the foregoing reagents. Specific activating agents are oxalyl chloride, phosphorous oxychloride and phosphorous trichloride, and more specifically oxalyl chloride and phosphorous oxychloride.

The reaction in step-(b) is carried out at a temperature of 25° C. to the reflux temperature of the solvent used for at least 30 minutes, specifically at a temperature of about 40° C. to the reflux temperature of the solvent used from about 1 hour to about 8 hours, and most specifically at a temperature of about 50° C. to about 100° C. from about 2 hours to about 5 hours.

In another embodiment, the activating agent in the molar ratio of about 3.0 to 4.0 moles, specifically about 3.5 to 4.0 moles, per 1 mole of 3-pyridylacetic acid or an acid addition salt thereof is used in order to ensure a proper course of the reaction.

After completion of the reaction in step-(b), the reaction mass may optionally be cooled at a temperature of below 85° C., and preferably at about 20° C. to about 80° C.

The admixing in step-(c) may be done in any order, for example, the water may be added to the reaction mass, or alternatively, the reaction mass may be added to the water. The addition may be carried out drop wise or in one portion or in more than one portion. The addition is preferably carried out at a temperature of below 85° C. for at least 20 minutes, and more preferably at a temperature of about 20° C. to about 80° C. from about 30 minutes to about 2 hours. After completion of the addition process, the admixture may preferably be heated at a temperature of above about 80° C. for at least 1 hour, and more preferably at about 80° C. to about 100° C. from about 2 hours to about 15 hours.

The reaction mass obtained in step-(c) or step-(d) may optionally be subjected to carbon treatment. The carbon treatment can be carried out by methods known in the art, for example by stirring the reaction mass with finely powdered carbon at a temperature of below about 70° C. for at least 15 minutes, preferably at a temperature of about 40° C. to about 70° C. for at least 30 minutes; and filtering the resulting mixture through hyflo to obtain a filtrate containing risedronic acid by removing charcoal. Preferably, finely powdered carbon is an active carbon.

The isolation of pure risedronic acid in step-(e) may be initiated by a method usually known in the art such as cooling, seeding, partial removal of the solvent from the solution, by adding an anti-solvent to the solution, or a combination thereof.

Preferably the isolation is carried out by adding an anti-solvent to the solution at a temperature of below 60° C., followed by cooling the solution at a temperature of below 30° C., and more preferably at about 0° C. to about 15° C., wherein the anti-solvent is selected from the group consisting of alcohols, ketones, amide solvents, and mixtures thereof.

Exemplary alcohol solvents include, but are not limited to, C₁ to C₈ straight or branched chain alcohol solvents such as methanol, ethanol, isopropyl alcohol, butanol, amyl alcohol, hexanol, and mixtures thereof. Specific alcohol solvents are methanol, ethanol, isopropyl alcohol, and mixtures thereof, and most specifically methanol. Exemplary ketone solvents include, but are not limited to, acetone, methyl ethyl ketone, methyl isobutyl ketone, methyl tert-butyl ketone, methylpyrrolidone and the like, and mixtures thereof. Specific ketone solvent is acetone. Exemplary amide solvents include, but are not limited to, dimethylformamide, dimethylacetamide, and mixtures thereof.

The solid obtained in step-(e) is collected by filtration or centrifugation.

The pure risedronic acid obtained by above process may be further dried in, for example, Vacuum Tray Dryer, Rotocon Vacuum Dryer, Vacuum Paddle Dryer or pilot plant Rota vapor, to further lower residual solvents. Drying can be carried out under reduced pressure until the residual solvent content reduces to the desired amount such as an amount that is within the limits given by the International Conference on Harmonization of Technical Requirements for Registration of Pharmaceuticals for Human Use (“ICH”) guidelines.

The risedronic acid obtained by the process disclosed herein, has a purity of (measured by High Performance Liquid Chromatography, hereinafter referred to as ‘HPLC’) greater than about 99%, specifically greater than about 99.5%, and more specifically greater than about 99.9%.

The aliphatic or alicyclic hydrocarbon solvent used for the bisphosphorylation reaction, allows the product to be easily isolated and purified, thereby producing a product with 70-75% overall yield.

The use of inexpensive, less hazardous, readily available and easy to handle aliphatic or alicyclic hydrocarbon solvents allows the process disclosed herein to be suitable for preparation of risedronic acid at lab scale and in commercial scale operations.

If required, pure risedronic acid obtained in step-(e) may be converted into pharmaceutically acceptable salts by conventional methods.

Pharmaceutically acceptable salts of risedronic acid, preferably hemi-pentahydrate monosodium salt, can be prepared in high purity by using the pure risedronic acid obtained by the method disclosed herein, by known methods.

According to another aspect of the present invention, there is provided substantially pure risedronic acid or a pharmaceutically acceptable salt thereof have a relatively low content of one or more organic volatile impurities.

The risedronic acid or a pharmaceutically acceptable salt thereof obtained by the process disclosed herein, having less than about 10 parts per million (ppm) n-octane, less than about 1000 ppm methanol and less than about 300 ppm isopropyl alcohol as measured by Gas Chromatography (GC). Specifically the risedronic acid or a pharmaceutically acceptable salt thereof obtained by the process disclosed herein, having less than about 2 parts per million (ppm) n-octane, less than about 600 ppm methanol and less than about 180 ppm isopropyl alcohol.

Specifically risedronic acid or a pharmaceutically acceptable salt thereof obtained by the process disclosed herein having the overall level of organic volatile impurities less than about 900 ppm, and more specifically less than about 800 ppm.

The term “substantially pure risedronic acid or a pharmaceutically acceptable salt thereof”, refers to the risedronic acid or a pharmaceutically acceptable salt thereof having purity greater than about 99%, specifically greater than about 99.90%, and more specifically greater than about 99.95% measured by HPLC.

Aptly the processes of this invention are adapted to the preparation of risedronic acid sodium salt, for example as a hydrate such as the hemiheptahydrate.

The invention also provides a process for the preparation of risedronic acid comprising the steps of a) reacting 3-pyridylacetic acid or an acid addition salt thereof with phosphorous acid in n-octane; b) adding to the reaction mixture obtained in step-(a) oxalyl chloride; c) heating the reaction mixture obtained in step-(b); and d) recovering risedronic acid.

### Experimental:

The purity was measured by high performance liquid chromatography by using Waters, alliance 2695 HPLC system having 2487 (UV) detector with Empower chromatography software under the following conditions:
Column: Kromasil C-18 (250×4.6 mm, 5μ) Make: Akzonoble, P/No: E23073 or Kromasil C-18 (250×4.6 mm, 5μ) Make: Grace, PN—62000 or its equivalent
Column oven temperature: 45° C.
Detection: UV at 262 nm
Flow rate: 1.0 mL/minute
Injection volume: 10 μl
Run time: 40 minutes
Diluent: Prepare a mixture of water and acetonitrile in the ratio of 85:15 (v/v)

The following examples are given for the purpose of illustrating the present invention and should not be considered as limitation on the scope or spirit of the invention.

### EXAMPLES

### Example 1

### Preparation of Risedronic Acid

3-Pyridyl acetic acid hydrochloride (25.0 g), phosphorous acid (35.42 g) and n-octane (300 ml) were taken in a reaction flask and heated at 90-95° C. for 30 minutes. The reaction mixture was cooled at 50-60° C. followed by addition of oxalyl chloride (109.66 g) and further heated at 90-95° C. and maintained for 3 hours. The reaction mixture was cooled at 25-30° C. followed by the addition of water (125 ml). The reaction mixture was heated at 90-95° C. The reaction mixture was then cooled at 55° C., which is then followed by the addition of methanol (250 ml). The reaction mixture was cooled at 0-5° C. The precipitated solid was filtered, washed with methanol and then dried to produce 25 g of risedronic acid (HPLC Purity: 99.5%).
Level of organic volatile impurities: n-octane—not detected, and methanol 590 ppm.

### Example 2

### Preparation of Risedronic Acid

3-Pyridyl acetic acid hydrochloride (100 g), phosphorous acid (188.94 g) and n-octane (700 ml) were taken in a reaction flask and heated at 85-90° C. for 30 minutes. This was followed by the drop wise addition of phosphorous oxychloride (353.29 g) at 85-90° C. and the resulting mixture was stirred for 3-4 hours at the same temperature. The resulting mass was cooled to 70-75° C. followed by the drop wise addition of water (50 ml) and then stirred for 20-30 minutes. This was followed by the addition of water (650 ml) in 30-40 minutes and the resulting mixture was heated to 85-90° C. and maintained for 12 hours. The resulting hot reaction mixture was filtered through hyflow bed and washed with hot water (100 ml) followed by the addition of methanol (1400 ml) at 30-50° C. in 30-40 minutes. The resulting mixture was cooled to 0-5° C. and then stirred for 1 hour. The resulting solid was filtered, washed four times with water (300 ml×4) and then dried the product in air oven at 60-65° C. for 5-6 hours to produce 130 g of risedronic acid (HPLC Purity: 99.6%).
Level of organic volatile impurities: n-octane—not detected, and methanol—600 ppm.

### Example 3

### Preparation of Risedronate Sodium Hemi-Pentahydrate

Risedronic acid (10 g, obtained in example 2) was suspended in water (100 ml) followed by the addition of a solution of 2-ethylsodium hexanoate (6.87 g) in water (25 ml). The resulting reaction mixture was heated at 60-65° C. to form a clear solution followed by the addition of isopropyl alcohol (250 ml) at the same temperature. The resulting suspension was cooled at 25-30° C. for 3 hours. The resulting white colored solid was filtered, washed with isopropyl alcohol (20 ml) and then dried under vacuum at 40-45° C. to produce 10 g of risedronate sodium hemi-pentahydrate (HPLC Purity: 99.9%; LOD: 11.9 to 13.9).
Level of organic volatile impurities: methanol—540 ppm, isopropyl alcohol—175 ppm and n-octane—not detected.

1. A process for the preparation of [1-hydroxy-2-(3-pyridinyl)ethylidene]bisphosphonic acid (Risedronic acid) or a pharmaceutically acceptable salt thereof, comprising:
a) forming a reaction mixture of 3-pyridylacetic acid or an acid addition salt thereof and phosphorous acid in a solvent selected from C₆ to C₈ aliphatic or alicyclic hydrocarbon;
b) reacting the reaction mixture obtained in step-(a) with oxalyl chloride;
c) admixing the reaction mass obtained in step-(b) with water;
d) optionally, filtering the reaction mass obtained in step-(c) to remove any extraneous matter; and
e) isolating substantially pure risedronic acid and optionally converting the risedronic acid obtained into its pharmaceutically acceptable salts thereof.

2. The process of claim 1, in which 3-pyridylacetic acid or an acid addition salt thereof and phosphorous acid are stirred together in a solvent selected from C₆ to C₈ aliphatic or alicyclic hydrocarbon in step-(a).

3. The process of claim 1, wherein the solvent in step-(a) is selected from the group consisting of n-heptane, n-octane, cyclohexane, and mixtures thereof.

4. The process of claim 1, wherein the acid addition salt used in step-(a) is hydrochloride salt.

5. The process of claim 1, wherein the solvent used in step-(a) is n-octane.

6. The process of claim 1, wherein the reaction mixture in step-(a) is maintained at a temperature of 25° C. to the reflux temperature of the solvent used for at least 15 minutes.

7. The process of claim 6, wherein the reaction mixture is maintained at a temperature of about 50° C. to about 100° C. for about 30 minutes to about 3 hours.

8. The process of claim 1, wherein the reaction mixture obtained after completion of the reaction in step-(a) is optionally cooled at a temperature of about 40° C. to about 65° C.

9. (canceled)

10. (canceled)

11. (canceled)

12. The process of claim 1, wherein the reaction in step-(b) is carried out at a temperature of 25° C. to the reflux temperature of the solvent used for at least 30 minutes.

13. (canceled)

14. The process of claim 1, wherein the oxalyl chloride in step-(b) is used in a molar ratio of 3.0 to 4.0 moles per 1 mole of 3-pyridylacetic acid or an acid addition salt thereof.

15. (canceled)

16. (canceled)

17. The process of claim 1, wherein the admixing in step-(c) is carried out at a temperature of about 20° C. to about 80° C. for about 30 minutes to about 2 hours, and wherein the admixture obtained is further heated at a temperature of about 80° C. to about 100° C. for about 2 hours to about 15 hours.

18. (canceled)

19. The process of claim 1, wherein the isolation of pure risedronic acid in step-(e) is initiated by cooling, seeding, partial removal of the solvent from the solution, by adding an anti-solvent to the solution, or a combination thereof.

20. The process of claim 19, wherein the isolation is carried out by adding an anti-solvent to the solution at a temperature of below 60° C. followed by cooling the solution at a temperature of below 30° C., and wherein the anti-solvent is selected from the group consisting of alcohols, ketones, amide solvents, and mixtures thereof.

21. The process of claim 20, wherein the anti-solvent is selected from the group consisting of methanol, ethanol, isopropyl alcohol, butanol, amyl alcohol, hexanol, acetone, methyl ethyl ketone, methyl isobutyl ketone, methyl tert-butyl ketone, methylpyrrolidone, dimethylformamide, dimethylacetamide, and mixtures thereof.

22. The process of claim 21, wherein the anti-solvent is methanol.

23. The process of claim 1, wherein the risedronic acid or a pharmaceutically acceptable salt thereof obtained has a purity of greater than about 99% as measured by HPLC.

24. (canceled)

25. (canceled)

26. (canceled)

27. (canceled)

28. (canceled)

29. Risedronic acid or a pharmaceutically acceptable salt thereof having less than about 10 parts per million (ppm) n-octane, less than about 1000 ppm methanol and less than about 300 ppm isopropyl alcohol, as measured by Gas Chromatography (GC), wherein the risedronic acid or a pharmaceutically acceptable salt thereof has a purity of greater than about 99% as measured by HPLC.

30. The compound of claim 29, wherein the risedronic acid or a pharmaceutically acceptable salt thereof has less than about 2 parts per million (ppm) n-octane, less than about 600 ppm methanol and less than about 180 ppm isopropyl alcohol, and wherein the risedronic acid or a pharmaceutically acceptable salt thereof has a purity of greater than about 99.9%.

31. (canceled)

32. (canceled)

33. The compound of claim 29, wherein the risedronic acid or a pharmaceutically acceptable salt thereof has the overall level of organic volatile impurities less than about 900 ppm, and wherein the pharmaceutically acceptable salt of risedronic acid is risedronate sodium salt.

34. The compound of claim 33, wherein the risedronic acid or a pharmaceutically acceptable salt thereof has the overall level of organic volatile impurities less than about 800 ppm, and wherein the pharmaceutically acceptable salt of risedronic acid is risedronate sodium hemi-pentahydrate.
